(19) United States
(12) Patent Application Publication
(10) Pub. No.: US 2022/0011439 A1
(43) Pub. Date: Jan. 13, 2022

(54) OPTICAL SYSTEM, IN PARTICULAR LIDAR SYSTEM, AND VEHICLE

(71) Applicant: Robert Bosch GmbH, Stuttgart (DE)

(72) Inventor: Stefan Spiessberger, Weinstadt (DE)

(21) Appl. No.: 17/294,294

(22) PCT Filed: Dec. 30, 2019
(86) PCT No.: PCT/EP2019/087137

§ 371 Date: May 14, 2021

(30) Foreign Application Priority Data
Jan. 23, 2019 (DE) 10 2019 200 764.3

(51) Int. Cl. G01S 17/931; G01S 7/481; B60W 40/02

(52) U.S. Cl. CPC G01S 17/931; B60W 2420/52; B60W 40/02; G01S 7/4817

(57) ABSTRACT

An optical system includes an optical transmitter which emits a scanning light beam into the surroundings along a first beam path, and an optical detector which receives a reflected light beam from the surroundings along a second beam path. In at least one of the first beam path and the second beam path, two mirror surfaces tilted relative to one another by 90° deflect the light beam from a first plane into a second, parallel plane. The mirror surfaces are rotatably supported and coupled to one another so that when the mirror surfaces are rotated together about a rotational axis perpendicular to the planes, scanning of the surroundings takes place so that no tilting of the light beam occurs during the rotation. Beamforming of the scanning light beam takes place, at least partially, via a curvature of the two mirror surfaces and/or via a beamformer in the first beam path.

### FIELD

The present invention relates to an optical system, in particular a LIDAR system, including at least one optical transmitter and at least one optical detector, the optical transmitter being configured to emit a scanning light beam into the surroundings along a first beam path, and the optical detector being configured to receive a reflected light beam from the surroundings along a second beam path, in at least one of the first beam path and the second beam path, mirror surfaces that are tilted relative to one another by 90° deflecting the light beam from a first plane into a second plane parallel thereto.

### BACKGROUND INFORMATION

Optical systems such as light detection and ranging (LIDAR) systems in particular are used, among other things, as radar-related methods for optical distance and velocity measurement. However, in contrast to radar, objects that are much smaller and closer may be measured with greater accuracy, as the result of which the technology has gained in importance in recent years, in particular for measuring the surroundings of vehicles.

However, it turned out to be difficult to achieve a large field of view (FoV) of the optical system without using multiple optical transmitters and optical detectors. Scanning LIDAR systems generally use a rotating element to achieve a spatial resolution, typically in the horizontal direction. There are two approaches in this regard:

In approach 1, the entire system rotates, including the optical transmitter (which generally includes one or multiple lasers) and the optical detector. This has the disadvantage that a power supply and a data transfer to the rotating element must be implemented.

Approach 2 avoids the disadvantages of approach 1, in that only a beam deflection optical system rotates, the optical transmitter and usually also the optical detector being stationary.

The rotating optical system is normally a mirror that deflects the emitted beam as well as the received beam over a certain angular range. Here as well, there are two approaches. On the one hand, there are systems in which the beam is situated on a plane before and after the beam deflection. The disadvantage of this variant is that for fairly large beam deflection angles, the effective transmission and detector surface area become smaller due to the effective mirror surface area decreasing. As a result, the angular spans of the achievable horizontal FoV are limited, and the resolution and accuracy of the system become increasingly poorer for larger deflection angles. The maximum transmission and detector surface areas would be reached at an angle of 0° (direct back-reflection of the scanning light beam). In this case, however, the emitted beam or the received beam would be blocked by the optical transmitter or the optical detector, respectively. For this reason, only angular ranges of typically 10° to 150° or −10° to −150° may be illuminated using this variant (the angle indicating the rotation angle of the mirror surface relative to a perpendicular incidence of the light beam). Thus, the field of view has a blind spot. Since for most applications the FoV must be continuous, generally only one side, for example 10° to 150°, is used.

Such approaches are described in U.S. Patent Application Publication No. US 2015 268 331 A1 and German Patent Application No. DE 10 2010 047 984 A1, for example.

On the other hand, there are systems in which the beam is typically deflected by 90°. FoVs of 360° may be easily achieved in this variant. However, when multiple pixels are emitted at different angles or in a laser line, the following disadvantage results: If the laser beam, already formed as a laser line, strikes the deflection optical system at an angle of approximately 45°, line illumination cannot be achieved without rotating the line orientation over large solid angles, since for a larger angle, a vertically oriented line is tilted in the direction of a horizontal line. This would mean that the vertical extension of the field of view would become smaller at larger deflection angles. However, in most applications this is not desirable and would impair the accuracy of the system as a function of the angle.

PCT Patent Application No. WO 2011/150942 A1 relates to wind turbines, and provides in particular an improved Doppler anemometer for determining the wind velocity with the aid of a LIDAR system. In one particular specific embodiment, for simplifying the design it is provided to mount the LIDAR system in question on a stator, and for tracking the wind direction, the beam path occurs via a rotatably supported deflection mirror. In addition, for improved alignment of the beam path with the wind direction, a deflection via a second mirror that is inclined by 45° is also provided.

European Patent No. EP 2 172 790 B1 describes a LIDAR system that includes a transmitting device and a receiving device. In particular, the document discloses components of a conventional optical system for detecting molecules, particles, and aerosols in the troposphere. The light beam with one diameter is deflected, with the aid of prisms, onto a light beam expander that expands the light beam to a larger diameter. The light beam is guided through a Z stage via two adjustable mirrors, the Z stage representing a nonrotatably supported periscope.

### SUMMARY

According to an example embodiment of the present invention, the mirror surfaces are rotatably supported and coupled to one another in such a way that when the mirror surfaces are rotated together about a rotational axis perpendicular to the two planes, scanning of the surroundings takes place in such a way that no tilting of the light beam occurs during the rotation, beam shaping of the scanning light beam taking place, at least partially, via a curvature of the two mirror surfaces and/or at least partially via a beamformer in the first beam path.

Thus, according to an example embodiment of the present invention, the scanning light beam (a laser beam, for example) is deflected via two mirror surfaces in such a way that after the beam deflection, the light beam that is emitted or reflected and received is situated on one of two parallel planes. As a result, tilting of the scanning light beam during the rotation of the mirror surfaces is prevented, and at the same time a large FoV is made possible.

According to the present invention, a double beam deflection by 90° takes place in each case via two mirror surfaces that may rotate together about an axis. For this purpose, in the simplest case the mirror surfaces are each tilted by 45° relative to the propagation plane of the scanning light beam.

The generated scanning light beam may initially be formed via a beamformer. Alternatively or additionally, the two mirror surfaces may take on a task in the beamforming. This means that one or both of the mirror surfaces may have a curvature or contain other optical elements. As a result, the design is simplified and less susceptible to errors.

The light beam is deflected twice by 90° in each case by the mirror surfaces. The two mirror surfaces rotate together about an axis. The deflected light beam leaves the deflection unit, which includes the two mirror surfaces, on a parallel plane that is far enough away from the incident plane that the beam may now pass through the optical transmitter unhindered. The optical detector functions in a similar way. In this case, a received reflected light beam is then deflected twice by 90° by a rotating deflection unit (striking a beamformer and/or being formed by the mirror surfaces), and is detected with the aid of the optical detector. Depending on the application, it may make sense to deflect both the optical transmitter and the optical detector, or in each case only the optical transmitter or the optical detector, in this way.

Within the scope of the disclosure herein, the term “optical” is to be construed broadly, and not only refers to visible light, but may also encompass infrared light and/or UV light. The optical transmitter may include one or multiple (preferably optical) lasers.

In one specific embodiment of the present invention, the optical transmitter and/or the optical detector are/is placed on a stator and do(es) not rotate together with the mirror surfaces. This simplifies the design, since a power supply and data link for rotating components do not have to be provided.

In a further preferred specific embodiment of the present invention, the first beam path and the second beam path are superimposed, so that both beam paths use the same mirror surfaces. The system may thus also have a coaxial design. This means that portions of the first and the second beam path are identical. Thus, the scanning light beam may then be initially shaped (expanded), and an inverse beamforming of the reflected light beam may then take place, at least partially, via a curvature of the two mirror surfaces and/or at least partially via a beamformer in the first/second beam path, using the same component(s). In this way, additional components in a separate second beam path, which are otherwise necessary, may be saved.

Alternatively, in the first beam path and in the second beam path, in each case a dedicated pair of mirror surfaces that are tilted relative to one another by 90° deflects the light beam from a first plane into a second plane parallel thereto. Depending on the specific embodiment, it may be desirable to spatially offset the optical detector from the optical transmitter.

In one preferred specific embodiment of the present invention, the scanning light beam is formed essentially into a line profile. The line profile has a finite length. “Essentially into a line profile” is understood here to mean that the line profile does not have an absolutely uniform linear form, but instead, merely has a greater extension along one of the two transverse axes perpendicular to the propagation direction. For example, the line profile may have an approximately elliptical cross section with a high level of eccentricity.

In one specific embodiment of the present invention, the line profile of the scanning light beam, due to the rotation of the mirror surfaces, does not rotate about the propagation direction. This may be achieved by the relative arrangement of the mirror surfaces according to the present invention, which compensates for tilting of a scanning light beam having a noncircular beam form, which otherwise occurs. A much more uniform scanning result may thus be achieved over the entire FoV.

Moreover, the present invention relates to a vehicle that includes at least one optical system according to one of the preceding specific embodiments, the optical system being installed in the vehicle in such a way that the scanning light beam scans the surroundings of the vehicle essentially horizontally.

In one specific embodiment of the present invention, the optical system provides a continuous horizontal field of view of at least 200°, preferably at least 250°, particularly preferably at least 300°. The unusually large field of view is achieved by the “bypassing” according to the present invention of the optical transmitter or of the optical detector due to shifting the scanning light beam into a parallel plane. Panoramic scanning is thus already achievable in principle using two scanning light beams, for example using two optical transmitters and two optical receivers.

In one specific embodiment of the present invention, the optical system is situated with the center of its continuous field of view in the main driving direction of the vehicle. In a vehicle-assisted application, a highest possible accuracy of the scanning in the driving direction is generally desirable in order to detect obstructions.

In one specific embodiment of the present invention, at least one optical system is situated with the center of its continuous field of view opposite the main driving direction of the vehicle. In a vehicle-assisted application, at the same time a highest possible accuracy of the scanning in the driving direction is likewise desirable in order to detect following vehicles or obstructions when backing up.

Advantageous refinements of the present invention are disclosed herein.

### BRIEF DESCRIPTION OF THE DRAWINGS

Exemplary embodiments of the present invention are explained in greater detail with reference to the figures and the description below.

FIG. 1 shows an optical system of the related art in a top view.

FIG. 2 shows an optical system of the related art, using a mirror with a 0° deflection angle.

FIG. 3 shows an optical system of the related art, using a mirror with a 90° deflection angle.

FIG. 4 shows an optical system according to an example embodiment of the present invention in a top view.

FIG. 5 shows an illustration of the first beam path in an optical system according to an example embodiment of the present invention.

FIG. 6 shows an optical system according to an example embodiment of the present invention with a 0° deflection angle.

FIG. 7 shows an optical system according to an example embodiment of the present invention with a 90° deflection angle.

### DETAILED DESCRIPTION OF EXAMPLE EMBODIMENTS

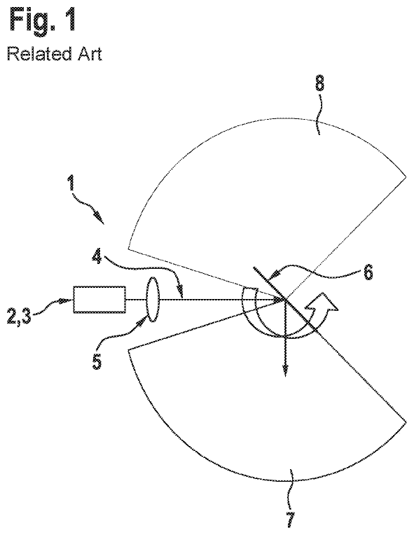

FIG. 1 shows an optical system 1 of the related art, which includes an optical transmitter 2 and an optical detector 3 that are accommodated in a shared housing. Optical transmitter 2 is configured to emit a scanning light beam into the surroundings along a first beam path 4. An optical element 5 for beamforming is situated in the beam path. The scanning light beam subsequently strikes a mirror surface 6, which deflects the light beam in order to scan the surroundings. The optical system includes two separate FoVs of 140° each, for example, situated to the right and left of a blind spot about a deflection angle of 0°. For this reason, often only one of the two FoVs is used, which greatly limits the functionality of the optical system.

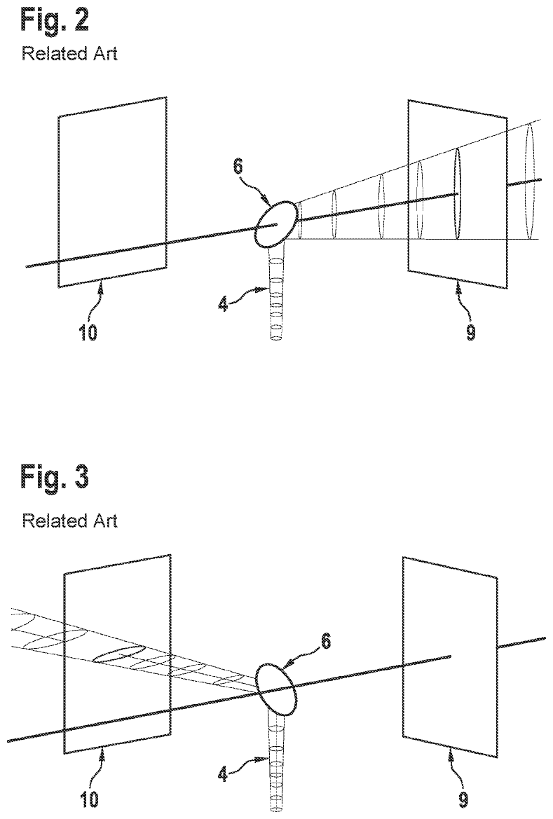

FIGS. 2 and 3 illustrate a further problem of the related art. Here, in comparison to FIG. 1, only beam path 4 and mirror surface 6 are illustrated for the sake of simplicity, as well as two screens 9, 10 that clarify the form of the scanning light beam. The scanning light beam is formed into a line profile in each case.

FIG. 2 shows a deflection angle of 0° in the scanning plane, the scanning light beam generating a perpendicular line profile on screen 9. Scanning (in a vehicle LIDAR system, for example) may thus take place in a certain range in the vertical direction.

If mirror surface 6 is now rotated by 90° as illustrated in FIG. 3, the scanning light beam is tilted in first beam path 4 and reaches screen 10 horizontally. The further the deflection angle deviates from 0°, the less importance the line profile also has for scanning in the vertical direction.

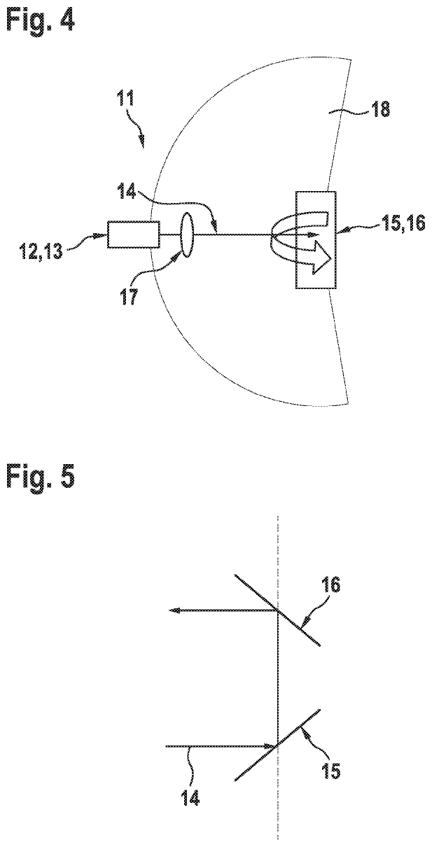

FIG. 4 shows an optical system 11 according to an example embodiment of the present invention, in particular a LIDAR system, that includes at least one optical transmitter 12 and at least one optical detector 13. Optical transmitter 12 is configured to emit a scanning light beam into the surroundings along a first beam path 14. Optical transmitter 12 may include a laser, for example. Optical detector 13 is configured to receive a reflected light beam from the surroundings along a second beam path (not explicitly illustrated). The second beam path may be superimposed on first beam path 14 in the opposite direction, as is the case here, but it may also be situated separately. Two mirror surfaces 15, 16 that are tilted relative to one another by 90° are situated in at least one of first beam path 14 and the second beam path, and deflect the light beam from a first plane into a second plane parallel thereto (cf. also FIG. 5).

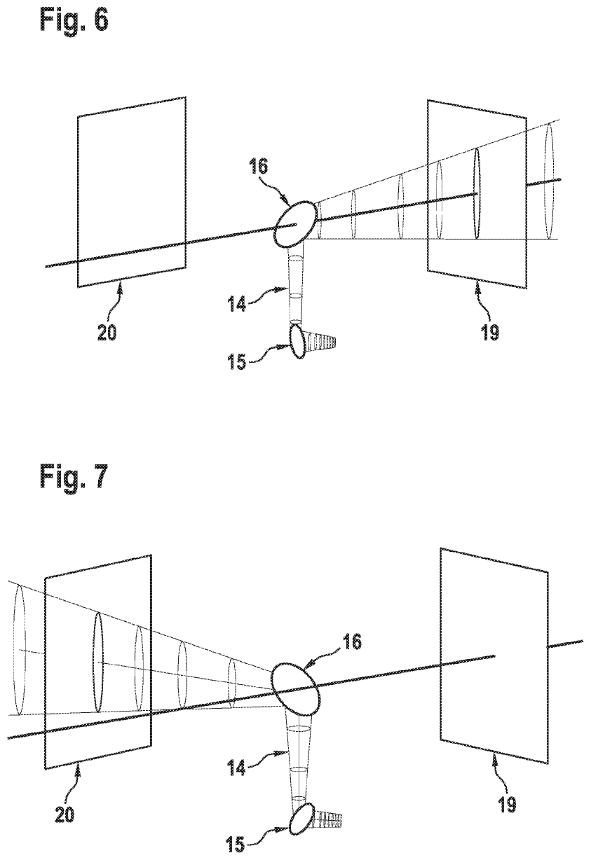

According to an example embodiment of the present invention, mirror surfaces 15, 16 are rotatably supported and coupled to one another in such a way that when they rotate together about a rotational axis perpendicular to the two planes, scanning of the surroundings takes place. No tilting of the light beam takes place during the rotation (cf. also FIGS. 6 and 7).

Beamforming of the scanning light beam takes place, at least partially, via a curvature of the two mirror surfaces and/or at least partially via a beamformer 17 in first beam path 14. The beam is subsequently deflected twice by 90° in each case by mirror surfaces 15, 16. The two mirror surfaces 15, 16 rotate together about an axis. The deflected beam leaves the deflection unit, which includes the two mirror surfaces 15, 16, on a parallel plane that is far enough away from the incident plane that the beam may now pass through the optical transmitter unhindered. However, the deflection unit may also include even further optical elements. Optical detector 13 functions in a similar way. In this case, a received light beam is then deflected twice by 90° by a rotating deflection unit, optionally strikes a beamformer, and is detected with the aid of optical detector 13. Depending on the application, it may make sense to deflect both first beam path 14 from optical transmitter 12 and the second beam path to optical detector 13, or in each case only first beam path 14 from optical transmitter 12 or only the second beam path to optical detector 13.

Alternatively or additionally, the two mirror surfaces 15, 16 may take on a task in the beamforming. This means that one or both of the mirror surfaces 15, 16 may have a curvature or contain other optical elements. Beamformer 17 illustrated in FIG. 4 is thus optional.

Optical system 11 includes a continuous horizontal field of view 18 of approximately 200°. However, fields of view of greater than 300° without interruptions are also achievable.

The unusually large field of view is achieved by the “bypassing” according to the present invention of optical transmitter 12 or of optical detector 13 due to shifting the scanning light beam into a parallel plane by a double reflection at mirror surfaces 15, 16. This is schematically illustrated in FIG. 5 in a simplified side view of the specific embodiment in FIG. 4. According to the present invention, the scanning light beam (a laser beam, for example) is deflected via the two mirror surfaces 15, 16 in such a way that after the beam deflection, the light beam that is emitted or reflected and received is situated on one of two parallel planes. In FIG. 5 the scanning light beam is shifted, in a manner of speaking, into a parallel, higher plane, so that optical transmitter 12 and optical detector 13 no longer block the scanning light beam.

According to the present invention, in each case a double beam deflection takes place by 90° via two mirror surfaces 15, 16 that may rotate together about an axis. For this purpose, in the simplest case the mirror surfaces are each tilted by 45° relative one another and relative to the propagation plane of the scanning light beam, as illustrated in FIG. 5.

At the same time, tilting of the scanning light beam during the rotation of mirror surfaces 15, 16 is prevented by using the two mirror surfaces 15, 16, as illustrated in FIGS. 6 and 7.

Similarly, as in FIGS. 2 and 3, for the sake of simplicity compared to FIG. 4, only first beam path 14 and mirror surfaces 15, 16 are illustrated, as well as two screens 19, 20. The scanning light beam is formed into a line profile in each case.

FIG. 6 shows a deflection angle of 0° in the scanning plane, the scanning light beam generating a perpendicular line profile on screen 19. Scanning (in a vehicle LIDAR system, for example) may thus take place in a certain range in the vertical direction.

If mirror surfaces 15, 16 together are now rotated by 90° as illustrated in FIG. 7, the scanning light beam in first beam path 14 is rotated only about the rotational axis of mirror surfaces 15, 16, without tilting taking place. The scanning light beam thus still generates a perpendicular line profile on screen 20. In comparison to the related art, it is thus possible to achieve not only a larger FoV, but also more uniform scanning in the FoV perpendicular to the scanning plane.

1-10. (canceled)

11. An optical system, comprising:
at least one optical transmitter;
at least one optical detector, the optical transmitter being configured to emit a scanning light beam into surroundings along a first beam path, and
the optical detector being configured to receive a reflected light beam from the surroundings along a second beam path; and
two mirror surfaces situated in at least one of the first beam path and the second beam path, the two mirror surfaces being tilted relative to one another by 90° and deflect the light beam from a first plane into a second plane parallel to the first plane, wherein the mirror surfaces are rotatably supported and coupled to one another in such a way that when the mirror surfaces are rotated together about a rotational axis perpendicular to the first and second planes, scanning of the surroundings takes place in such a way that no tilting of the light beam occurs during the rotation, beamforming of the scanning light beam taking place, at least partially, via a curvature of the two mirror surfaces and/or at least partially via a beamformer in the first beam path.

12. The optical system as recited in claim 11, wherein the optical system is a LIDAR system.

13. The optical system as recited in claim 11, wherein the optical transmitter and/or the optical detector is on a stator and does not rotate together with the mirror surfaces.

14. The optical system as recited in claim 11, wherein the first beam path and the second beam path are superimposed, so that both the first and second beam paths use the same mirror surfaces.

15. The optical system as recited in claim 11, wherein in the first beam path and in the second beam path, in each case, a dedicated pair of mirror surfaces that are tilted relative to one another by 90° deflects the light beam from a first plane into a second plane parallel to the first plane.

16. The optical system as recited in claim 11, wherein the scanning light beam is formed into a line profile.

17. The optical system as recited in claim 16, wherein the line profile of the scanning light beam, due to the rotation of the mirror surfaces, does not rotate about a propagation direction.

18. A vehicle that includes an optical system, the optical system comprising:
at least one optical transmitter;
at least one optical detector, the optical transmitter being configured to emit a scanning light beam into surroundings along a first beam path, and
the optical detector being configured to receive a reflected light beam from the surroundings along a second beam path; and
two mirror surfaces situated in at least one of the first beam path and the second beam path, the two mirror surfaces being tilted relative to one another by 90° and deflect the light beam from a first plane into a second plane parallel to the first plane,
wherein the mirror surfaces are rotatably supported and coupled to one another in such a way that when the mirror surfaces are rotated together about a rotational axis perpendicular to the two planes, scanning of the surroundings takes place in such a way that no tilting of the light beam occurs during the rotation, beamforming of the scanning light beam taking place, at least partially, via a curvature of the two mirror surfaces and/or at least partially via a beamformer in the first beam path;
wherein the optical system is installed in the vehicle in such a way that the scanning light beam scans the surroundings of the vehicle horizontally.

19. The vehicle as recited in claim 18, wherein the optical system provides a continuous horizontal field of view of at least 200°.

20. The vehicle as recited in claim 18, wherein the optical system provides a continuous horizontal field of view of at least 250°.

21. The vehicle as recited in claim 18, wherein the optical system provides a continuous horizontal field of view of at least 300°.

22. The vehicle as recited in claim 19, wherein the optical system is situated with a center of its continuous field of view in a main driving direction of the vehicle.

23. The vehicle as recited in claim 19, wherein the optical system is situated with a center of its continuous field of view opposite a main driving direction of the vehicle.
